(19) United States
(12) Patent Application Publication
(10) Pub. No.: US 2018/0107223 A1
(43) Pub. Date: Apr. 19, 2018

(54) METHOD AND SYSTEM FOR GENERATING NAVIGATION DATA AND TRANSPORTING OBJECT

(71) Applicant: CAINIAO SMART LOGISTICS HOLDING LIMITED, Grand Cayman (KY)

(72) Inventors: CHENGXING ZHONG, HANGZHOU (CN); PENG CHEN, HANGZHOU (CN); JUNBO CHEN, HANGZHOU (CN)

(21) Appl. No.: 15/784,866

(22) Filed: Oct. 16, 2017

(30) Foreign Application Priority Data
Oct. 18, 2016 (CN) 201610908458.6

(51) Int. Cl. G05D 1/02; G01C 21/34; G01C 21/36

(52) U.S. Cl. CPC G05D 1/0212; G01C 21/343; G06Q 10/08355; G05D 1/0274; G05D 2201/0216; G01C 21/3679

(57) ABSTRACT

The disclosure provides systems and method for generating navigation data. An exemplary method comprises: determining a navigation route according to a received object transport request, wherein the navigation route comprises an object transport starting point, one or more intermediate nodes, and an object transport ending point; determining node types of the intermediate nodes, the node types indicating actions to be executed by a vehicle at the corresponding nodes; and obtaining navigation data based at least on the navigation route and the node types of the intermediate nodes.

### CROSS REFERENCE TO RELATED APPLICATIONS

The present application is based on and claims priority to the Chinese Application No. 201610908458.6, filed Oct. 18, 2016, the entire contents of which are incorporated herein by reference.

### TECHNICAL FIELD

The present application relates to the field of navigation, and more specifically, to methods and systems for generating navigation data and transporting objects.

### BACKGROUND

In current logistics and transportation systems, a package is typically delivered by a courier to a final receipt address. If the recipient is away or otherwise cannot sign off the receipt, the package will be delivered to a package collect center, where the recipient will pick up the package later.

For example, if the receipt address is an address inside an industrial park, which has a package collect center, a courier can deliver the package to the package collect center, so that the recipient can pick up the package from the package collect center on his/her own.

In view of the above, picking up the package from the package collect center can be onerous and inconvenient for the recipient.

### SUMMARY

The disclosure provides an object transport system, which uses vehicles to achieve automatic transportation of objects, providing convenience to the recipients.

According to one aspect, the disclosure provides a method for generating navigation data, comprising: upon receiving an object transport request, determining a navigation route according to the object transport request; wherein the navigation route comprises an object transport starting point, intermediate nodes, and an object transport ending point, the intermediate nodes being nodes other than the transport starting point and the transport ending point; determining node types of intermediate nodes of the navigation route, the node types indicating actions to be executed by a vehicle at the nodes; and using the navigation route and node types of the intermediate nodes of the navigation route to generate navigation data.

According to another aspect, the disclosure provides a method for providing navigation data that is applied to a vehicle. The method may comprise: after obtaining the navigation data, extracting a navigation route therein and node types corresponding to intermediate nodes of the navigation route; wherein the navigation route comprises several nodes and the intermediate nodes are nodes in the several nodes other than the transport starting point and the transport ending point; and controlling the vehicle to start transporting an object from the transport starting point, and when the vehicle arrives at the intermediate nodes, controlling the vehicle to execute actions corresponding to the node types of the intermediate nodes, until the vehicle arrives at the transport ending point.

According to yet another aspect, the disclosure provides an apparatus for generating navigation data, comprising: a navigation route determining unit, configured to determine, upon receiving an object transport request, a navigation route according to the object transport request; wherein the navigation route comprises an object transport starting point, intermediate nodes, and an object transport ending point, the intermediate nodes being nodes other than the transport starting point and the transport ending point; a node type determining unit, configured to determine node types of intermediate nodes of the navigation route, the node types being used to indicate actions to be executed by a vehicle at the nodes; and a navigation data generating unit, configured to use the navigation route and node types of the intermediate nodes of the navigation route to generate navigation data.

According to yet another aspect, the disclosure provides an object transport apparatus that is applied to a vehicle. The apparatus may comprise: a navigation route and node type obtaining unit configured to extract, after obtaining the navigation data, a navigation route therein and node types corresponding to the intermediate nodes of the navigation route; wherein the navigation route comprises several nodes and the intermediate nodes are nodes in the several nodes other than the transport starting point and the transport ending point; and an object transport controlling unit configured to control the vehicle to start transporting an object from the transport starting point, and when the vehicle arrives at the intermediate nodes, control the vehicle to execute actions corresponding to the node types of the intermediate nodes, until the vehicle arrives at the transport ending point.

According to yet another aspect, the disclosure provides a server that comprises a processor and a communication port. The processor is configured to determine, upon receiving an object transport request, a navigation route according to the object transport request. The navigation route comprises an object transport starting point, intermediate nodes, and an object transport ending point, the intermediate nodes being nodes other than the transport starting point and the transport ending point. The process is further configured to determine node types of intermediate nodes of the navigation route, the node types being used to indicate actions to be executed by a vehicle at the nodes. The processor can be further configured to use the navigation route and node types of the intermediate nodes of the navigation route to generate navigation data. The communication port is configured to transmit the navigation data.

According to yet another aspect, the disclosure provides a vehicle, comprising a communication port, a processor, a positioning apparatus, and an action part. As will be described below, the action part can include wheels, and/or other components that can move the vehicle or take an action on an object. The communication port is configured to receive the navigation data. The positioning apparatus is configured to determine the position of the vehicle in real time. The processor is configured to extract a navigation route in the navigation data and node types corresponding to the intermediate nodes of the navigation route. The navigation route comprises several nodes and the intermediate nodes are nodes in the several nodes other than the transport starting point and the transport ending point. The process is further configured to send a moving instruction, according to the position determined by the positioning apparatus and the navigation route, to the action part, and also configured to send an action instruction, according to the node type, to the action part. The action part is configured to start transporting an object from the transport starting point according to the moving instruction, and when the vehicle arrives at the intermediate nodes, execute an action corresponding to the action instruction, until the vehicle arrives at the transport ending point.

According to yet another aspect, the disclosure provides a vehicle, comprising a processor, a positioning apparatus, and an action part. The positioning apparatus is configured to determine the position of the vehicle in real time. The processor is configured to determine, upon receiving an object transport request, a navigation route according to the object transport request, and determine node types of intermediate nodes of the navigation route. The navigation route comprises an object transport starting point, intermediate nodes, and an object transport ending point, the intermediate nodes being nodes other than the transport starting point and the transport ending point, and the node types being used to indicate actions to be executed by the vehicle at the nodes. The processor may be further configured to send a moving instruction, according to the position determined by the positioning apparatus and the navigation route, to the action part, and configured to send an action instruction, according to the node type, to the action part. The action part is configured to start transporting an object from the transport starting point according to the moving instruction, and when the vehicle arrives at the intermediate nodes, execute an action corresponding to the action instruction, until the vehicle arrives at the transport ending point.

According to yet another aspect, the disclosure provides an object transport system, comprising a server and a vehicle. The server is configured to generate navigation data according to an object transport request from a client terminal and send the navigation data to the vehicle. The navigation data comprises a navigation route, the navigation route comprises several nodes, each node has a corresponding node type, and the node types are used to indicate actions to be executed by the vehicle at the nodes. The vehicle is configured to transport, according to the navigation data, an object from the starting point to the ending point of the navigation route.

According to yet another aspect, a method for generating navigation data comprises: determining a navigation route according to a received object transport request. The navigation route comprises an object transport starting point, one or more intermediate nodes, and an object transport ending point. The method further comprises determining node types of the intermediate nodes, the node types indicating actions to be executed by a vehicle at the corresponding nodes, and obtaining navigation data based at least on the navigation route and the node types of the intermediate nodes.

According to yet another aspect, an object transport method, implementable on a vehicle, comprises extracting a navigation route and node types corresponding to intermediate nodes of the navigation route from obtained navigation data. The navigation route comprises a transport starting point, the intermediate nodes, and a transport ending point. The method further comprises controlling the vehicle to transport an object from the transport starting point to the transport ending point, and when the vehicle arrives at the intermediate nodes, controlling the vehicle to execute actions corresponding to the node types of the intermediate nodes.

According to yet another aspect, an apparatus for generating navigation data comprises a processor and a non-transitory computer-readable storage medium storing instructions that, when executed by the processor, cause the apparatus to perform a method. The method comprises: determining a navigation route according to a received object transport request, wherein the navigation route comprises an object transport starting point, one or more intermediate nodes, and an object transport ending point; determining node types of the intermediate nodes, the node types indicating actions to be executed by a vehicle at the corresponding nodes; and obtaining navigation data based at least on the navigation route and the node types of the intermediate nodes.

According to yet another aspect, an object transport apparatus, implementable on a vehicle, comprises a processor and a non-transitory computer-readable storage medium storing instructions that, when executed by the processor, cause the apparatus to perform a method. The method comprises: extracting a navigation route and node types corresponding to intermediate nodes of the navigation route from obtained navigation data, wherein the navigation route comprises a transport starting point, the intermediate nodes, and a transport ending point; and controlling the vehicle to transport an object from the transport starting point to the transport ending point, and when the vehicle arrives at the intermediate nodes, controlling the vehicle to execute actions corresponding to the node types of the intermediate nodes.

According to yet another aspect, a server comprises a processor configured to: determine a navigation route according to a received object transport request, wherein the navigation route comprises an object transport starting point, one or more intermediate nodes, and an object transport ending point; determine node types of the intermediate nodes, the node types indicating actions to be executed by a vehicle at the corresponding nodes; and obtain navigation data based at least on the navigation route and the node types of the intermediate nodes. The server further comprises a communication port configured to transmit the navigation data.

According to yet another aspect, a vehicle comprises: a communication port configured to receive navigation data comprising one or more intermediate nodes; a positioning apparatus configured to determine a position of the vehicle in real time; a processor configured to: extract a navigation route in the navigation data and node types corresponding to the intermediate nodes, wherein the navigation route comprises a transport starting point, the intermediate nodes, and a transport ending point; and send a moving instruction, according to the determined position and the navigation route, to the action part; and configured to send an action instruction, according to the node type, to an action part; and the action part configured to transport an object from the transport starting point to the transport ending point according to the moving instruction, and when the vehicle arrives at each of the intermediate nodes, execute an action corresponding to the action instruction.

According to yet another aspect, a vehicle comprises: a positioning apparatus configured to determine a position of the vehicle in real time; a processor configured to: determine a navigation route according to a received object transport request and determine node types of one or more intermediate nodes, wherein the navigation route comprises an object transport starting point, the intermediate nodes, and an object transport ending point, and the node types indicate actions to be executed at the nodes; and send a moving instruction, according to the determined position and the navigation route, to the action part; and configured to send an action instruction, according to the node type, to an action part; and the action part configured to start transport an object from the transport starting point to the transport ending point according to the moving instruction, and when the vehicle arrives at each of the intermediate nodes, execute an action corresponding to the action instruction.

In various embodiments, the disclosure provides an object transport system, and the system comprises a server and a vehicle, wherein the server generates navigation data according to an object transport request from a user, the navigation data comprises a navigation route and a node type of each intermediate node of the navigation route, the node type is used to indicate actions to be executed by the vehicle at each intermediate node, and the vehicle achieves the object transport according to the navigation data. This type of object transport system can achieve automatic transportation of objects and save labor costs.

### BRIEF DESCRIPTION OF THE DRAWINGS

The accompanying drawings in the following description are merely embodiments of the disclosure. To a person skilled in the art, other drawings may be obtained according to the provided drawings without inventive effort.

FIG. 1 is a structural diagram of an object transport system according to the disclosure.

FIG. 2 illustrates an example of an object transport route according to the disclosure.

FIG. 3 is a flow chart of a method for generating navigation data according to the disclosure.

FIG. 4 is a schematic diagram of a navigation route according to the disclosure.

FIG. 5 is another flow chart of the method for generating navigation data according to the disclosure.

FIG. 6A and FIG. 6B are schematic diagrams of deleting an intermediate node of a navigation route according to the disclosure;

FIG. 7 is a flow chart of an object transport method according to the disclosure.

FIG. 8 is a flow chart of charging control performed on a vehicle according to the disclosure.

FIG. 9 is a structural diagram of an apparatus for generating navigation data according to the disclosure.

FIG. 10 is a structural diagram of an object transport apparatus according to the disclosure.

FIG. 11 and FIG. 12 are schematic diagrams of a host architecture of a general-purpose computer for a server and a vehicle according to the disclosure.

FIG. 13 is a structural diagram of a vehicle according to the disclosure.

### DETAILED DESCRIPTION

The described embodiments are merely some, rather than all, of the embodiments of the disclosure. All other embodiments obtained by a person skilled in the art without inventive effort and on the basis of the embodiments of the disclosure shall be encompassed by the present disclosure.

In a logistic process of delivering packages, intelligent robots may be used for automatic delivery. For example, an intelligent robot obtains a package from one location and transports it to another location, to replace manual package collection. For different working environments, the intelligent robot will have different delivery processes.

In a working environment, various buildings may locate on a delivery route of an intelligent robot, and the intelligent robot needs to execute different movement actions according to different buildings. For example, when there is a tall building in the working environment, the intelligent robot not only needs to go around obstacles on the delivery route, but also needs to execute actions like entering the building and riding an elevator.

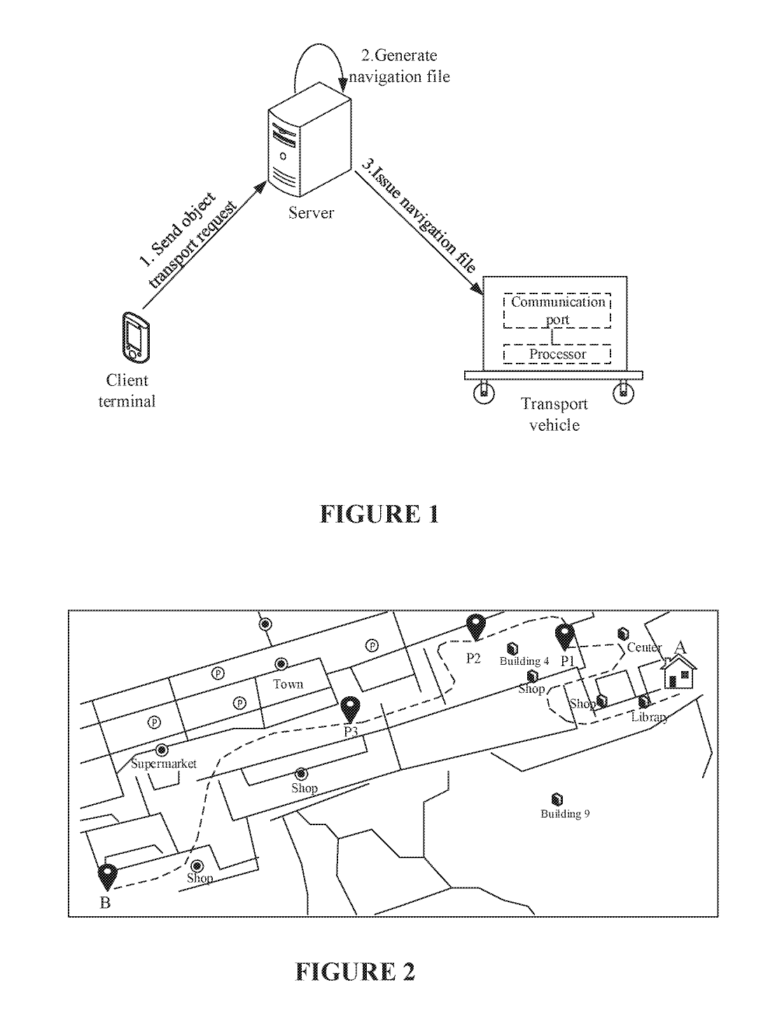

Referring to FIG. 1, the disclosure provides an object transport system, which can comprise a server and a vehicle (e.g., transport vehicle).

The server is configured to generate navigation data according to an object transport request from a client terminal and send the navigation data to the vehicle.

Here, the navigation data may be recorded in a file, and then the file may be referred to as a navigation file. The navigation data is used to instruct resource distribution in a space. The space is not limited to a space at a fixed place. It can also be a non-enclosed space from one position point to another position point via an outdoor route.

The navigation data comprises a navigation route, and the navigation route comprises several nodes. For example, the nodes may comprise geographic coordinates, and the navigation route can be shown by connecting geographic coordinates in sequence. The navigation route is a route along which the vehicle will move.

The nodes can be used to instruct the vehicle to move from one position point to another position point, and each position point may correspond to an object like a building, a facility affiliated to a building, a natural object, etc. When the vehicle arrives at a node, it may execute a corresponding action according to the type of the object at the node. Therefore, each node may be set with a node type used to indicate the type of an object at a node. For example, a node type may be door, another node type may be elevator, and yet another node type may be corner.

The vehicle is configured to transport, according to the navigation data, an object from one place to another place.

The vehicle may be an intelligent robot, and as shown in FIG. 1, it comprises a communication port, a processor, and an action part. The communication port is configured to receive the navigation data sent from the server, and the processor is configured to control, according to the navigation data, the action part to move, such that the vehicle transports an object from one place to another place.

Alternatively, the vehicle may comprise a device like a self-balancing scooter or a wheelchair. The object transported by the vehicle may be a package or a person.

A movement route of the vehicle is shown in FIG. 2. A vehicle travels from Point A to Point B along the dash line, which indicates the navigation route in the navigation data sent to the vehicle from the server. Points P1 to P3 on the dash line indicate three nodes on the navigation route, and the node types of these three nodes are door, corner 1, and corner 2, respectively. When traveling to each node along the navigation route, the vehicle needs to execute a corresponding action according to the node type of the each node. For example, when arriving at Point P1, the vehicle needs to execute a door-crossing action, and when arriving at corner 1 and corner 2, the vehicle needs to execute a turning action. With the guidance by the navigation route, the vehicle can arrive at Point B and complete the object transport.

In some embodiments, Point A to Point B on the navigation route may also function as a node with a node type of starting point and ending point, respectively, and the actions to be executed by the vehicle is to collect an object and to deliver an object, correspondingly.

As such, the server may be configured to generate navigation data according to an object transport request from a user, and the vehicle may be configured to guide itself according to the navigation data and transport an object. The server and the vehicle will be described below, respectively.

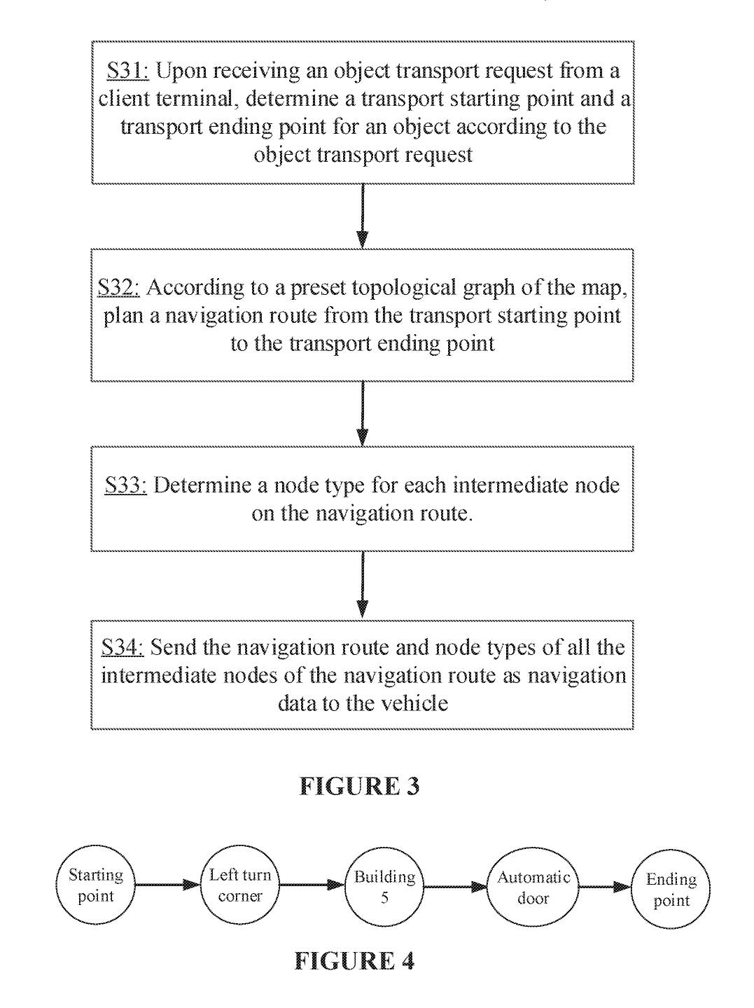

FIG. 3 is a flow chart of a method for generating navigation data, which may comprise the steps of S31 to S34. The method may be implementable on a server.

S31 includes upon receiving an object transport request from a client terminal, determining a transport starting point and a transport ending point for an object according to the object transport request.

Here, if the user wants to use a vehicle to transport the object, the object transport information may be input to the client terminal, and the input object transport information is transmitted to the server as a part of the object transport request.

In one example, the object transport information input by a user comprises a transport starting point and a transport ending point for an object. Upon receiving the object transport request, the server may extract the transport starting point and the transport ending point directly from the object transport request. In another example, the object transport information input by a user comprises an object identification, such a complete tracking number, the last four digits of a tracking number, or a QR code containing a tracking number. Upon receiving the object transport request, the server may check the transport starting point and the transport ending point of the object according to the object identification. In some embodiments, the server needs to store a corresponding relationship between object identifications and transport starting points and transport ending points.

In yet another example, the server stores a corresponding relationship between object identifications and transport starting points, and the object transport information input by a user comprises an object identification and a transport ending point of the object. Upon receiving the object transport request, the server directly extracts the transport ending point therefrom and checks the transport starting point according to the object identification. In yet another example, the server stores a corresponding relationship between object identifications and transport ending points, and the object transport information input by a user comprises an object identification and a transport starting point of the object. Upon receiving the object transport request, the server directly extracts the transport starting point therefrom and checks the transport ending point according to the object identification.

Compared with the first example, the latter three examples require a server to pre-execute pre-processing steps and take up certain storage capacity. To a user, however, there is less information to be input and the user experience is better.

An object to be transported has different transport starting points and transport ending points in different application scenarios of the vehicle. For example, if the vehicle is applied in an industrial park, the transport starting point may be an object depositary provided in the industrial park, and the transport ending point may be a work station on a floor in a building of the industrial park.

S32 includes, according to a preset topological graph of the map, planning a navigation route from the transport starting point to the transport ending point.

In some embodiments, a topological graph of the map corresponding to the working environment of the vehicle is preset on the server. For example, for a vehicle works in an industrial park, a topological graph of the map of the industrial park can be preset on the server. A topological graph of a map comprising more details such as nodes and lines connecting the nodes (e.g., node representing locations and lines representing routes) can model the working environment more precisely, to generate an optimal route and an accurate transport process by the vehicle.

In some embodiments, any route planning algorithm may be used to determine a navigation route. Different route planning algorithms will lead to navigation routes that have different advantages. For example, when a shortest route planning algorithm, such as the TSP (Traveling Salesman Problem) algorithm, is used, the determined navigation route has the shortest length. For another example, when a shortest time planning algorithm is used, the determined navigation route has the shortest travel time. For another example, if the navigation route comprises a plurality of object collection points and/or a plurality of object delivery points, the Dijistra algorithm can be used.

A planned navigation route may comprise several nodes, and an example navigation route comprises a node list. Moreover, all nodes in the node list can be arranged in an order. As such, the route between one node and the next node indicates a small segment of the navigation route.

Thus, steps S31 and S32 may include determining a navigation route according to a received object transport request. The navigation route may comprise an object transport starting point, one or more intermediate nodes, and an object transport ending point.

S33 includes determining a node type for each intermediate node on the navigation route.

In some embodiments, various nodes of a navigation route may only be used to indicate a route, and not to indicate the type of a building to which the node corresponds. For example, as shown in FIG. 2, the navigation route comprises five nodes, which are Node A, Node 1, Node 2, Node 3, and Node B. However, buildings corresponding to these five nodes are not determined from the navigation route. Since a navigation robot needs to execute corresponding actions according to a building type, it is necessary to determine the node type of each node. The node type refers to a building to which a node corresponds in an actual environment. For example, the node type may comprise bridge, left turn corner, Building 1, Building 2, automatic door, elevator, etc.

In some embodiments, a navigation route comprises an object transport starting point (“starting point”) and an object transport ending point (“ending point”). The corresponding node type can be directly determined for these two points, which are collecting an object and delivering an object, respectively. Alternatively, no node type needs to be determined for these two points. When a vehicle moves to these two nodes, collecting and delivering the object can be carried out manually.

In some embodiments, nodes other than the transport starting point and the transport ending point may be referred to as intermediate nodes.

In some embodiments, an object transport request may correspond to one or more objects. An object transport request for a plurality of objects can comprise a request for a vehicle to collect a plurality of objects at one position point and transport the plurality of objects to a plurality of position points. Alternatively, a vehicle can be requested to collect objects from a plurality of position points and transport the plurality of objects to a plurality of position points. In these examples, there can be a plurality of object transport starting points and/or object transport ending points on a navigation route determined by the server. Therefore, when intermediate nodes are determined, the plurality of transport starting points and/or transport ending points (e.g., all but one starting point and one ending point) can be removed.

After the intermediate nodes are determined, a corresponding node type can be determined for the each intermediate node according to the node type file. As described above, a topological graph of the map may be preset on the server, and the topological graph of the map comprises nodes and lines. The server may pre-store a node type file corresponding to the topological graph of the map, and the node type file comprises a node type of each node in the topological graph of the map. Therefore, the node type of an intermediate node can be obtained from the node type file.

For example, a navigation route comprises three intermediate nodes in addition to a transport starting point and a transport ending point. The node type determined for the intermediate node 1 is left-turn corner, the node type determined for the intermediate node 2 is Building 5, and the node type determined for the intermediate node 3 is automatic door.

The node type can indicate actions to be executed by a vehicle at the node. For example, if the node type is left-turn corner, a vehicle is instructed to turn left; if the node type is Building 5, a vehicle is instructed to travel to Building 5; and if the node type is automatic door, a vehicle is instructed to wait for the door to open and then pass through. The above node types and corresponding actions are merely examples, and the disclosure is not limited thereto.

Thus, step S33 may include determining node types of the intermediate nodes, the node types indicating actions to be executed by a vehicle at the corresponding nodes. Determining the node types of the intermediate nodes may comprise: searching for the node types of the intermediate nodes in a node type file, wherein the node type file comprises node types of all nodes in a topological map.

S34 includes sending the navigation route and node types of all the intermediate nodes of the navigation route as navigation data to the vehicle. For example, step 34 may include obtaining navigation data based at least on the navigation route and the node types of the intermediate nodes.

An exemplary illustration of the navigation data is shown in FIG. 4. As shown in FIG. 4, the navigation data corresponds to 5 circles, the first circle indicates an object transport starting point, the second circle indicates a left-turn corner, the third circle indicates a Building 5, the fourth circle indicates an automatic door, and the fifth circle indicates an object transport ending point. In addition, the arrows between the circles indicate a small segment of the navigation route for guiding the vehicle to travel from one node to the next node, until the object transport ending point is reached.

A method for generating navigation data is described above. The method may be implementable on a server. The method can be applied in object transport tasks with relatively simple navigation routes. For example, when a vehicle passes through a door and enters a building, it may not need to take an elevator to go upstairs, and just need to directly reach an object collection point on the first floor.

The navigation data generated by the above method comprises node types for the intermediate nodes on the navigation route. Therefore, the vehicle needs to execute a corresponding action at every node. However, this method may lower the work efficiency of the vehicle.

In some embodiments, many identical nodes may exist in the intermediate nodes of a navigation route. For example, the object transport ending point is a position point on the 13^{th} floor of a building, and a navigation route determined according to a topological graph of the map comprises the 1^{st} to the 13^{th} floors of the building. When an elevator for these floors is used as intermediate nodes, the elevator on the 2^{nd} to the 12^{th} floors corresponds to identical nodes, because the vehicle does not need to execute an action of moving out the elevator when passing through the elevators on the 2^{nd} to the 12^{th} floors.

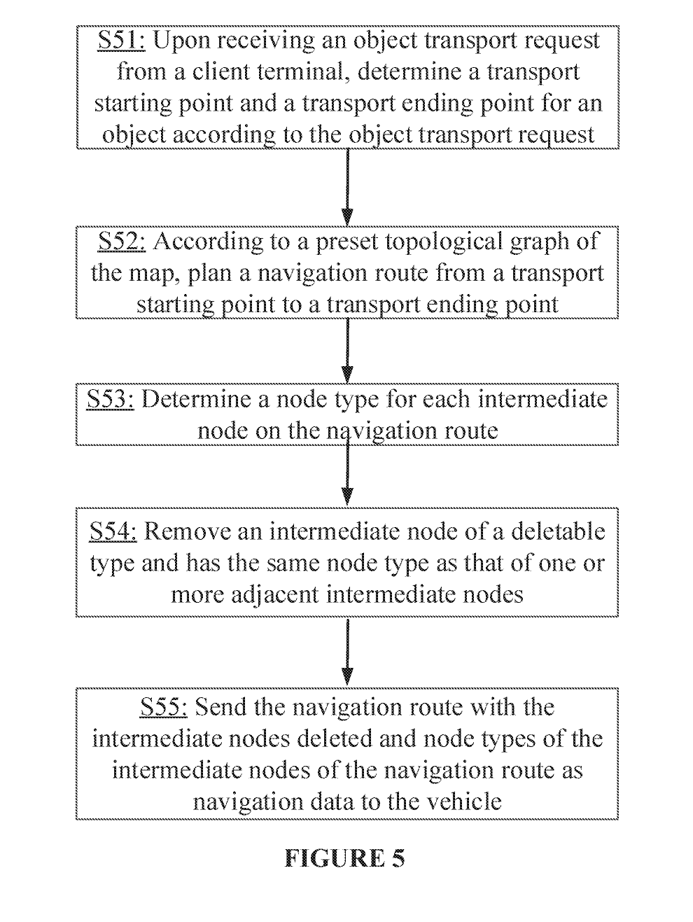

Therefore, to ensure the object transport efficiency of the vehicle, identical intermediate nodes can be combined. FIG. 5 is another flow chart of the method for generating navigation data according to the disclosure, which can comprise the steps of S51 to S55. The method may be implementable on a server.

S51 includes, upon receiving an object transport request from a client terminal, determining a transport starting point and a transport ending point for an object according to the object transport request.

S52 includes, according to a preset topological graph of the map, planning a navigation route from a transport starting point to a transport ending point.

S53 includes determining a node type for each intermediate node on the navigation route.

The description of the steps S31 to S33 may be referenced for a description of the steps of S51 to S53, which will not be repeated herein.

S54 includes removing an intermediate node of a deletable type and has the same node type as that of one or more adjacent intermediate nodes. That is, after determining node types of the intermediate nodes, the method may further comprises: removing an intermediate node of a deletable type from the intermediate nodes in response to determining that the deletable intermediate node and one or more immediately adjacent intermediate nodes have a same node type. And obtaining the navigation data based at least on the navigation route and the node types of the intermediate nodes (S34 described above) may comprise: obtaining navigation data based at least on the navigation route with the deletable intermediate node removed and the node types of the intermediate nodes.

In some embodiments, the deleted intermediate node is of a preset deletable type. For example, if the intermediate node is an elevator floor, the intermediate node can be deleted. However, some intermediate nodes may not be combined. If two consecutive intermediate nodes correspond to two buildings, the two intermediate nodes indicate that a vehicle needs to travel from one building to the other. This type of intermediate nodes cannot be deleted.

In addition, the deleted intermediate node has the same node type as that of the previous intermediate node, and also has the same node type as that of the next intermediate node. With the above elevator nodes on the 1^{st} floor to the 13^{th} floor as an example, the elevator nodes on the 2^{nd} floor to the 12^{th} floor can be deleted. If the elevator nodes on a navigation route are elevator nodes on two adjacent floors, such as elevator nodes on the 1^{st} floor and the 2^{nd} floor, no elevator nodes on any floor will be deleted.

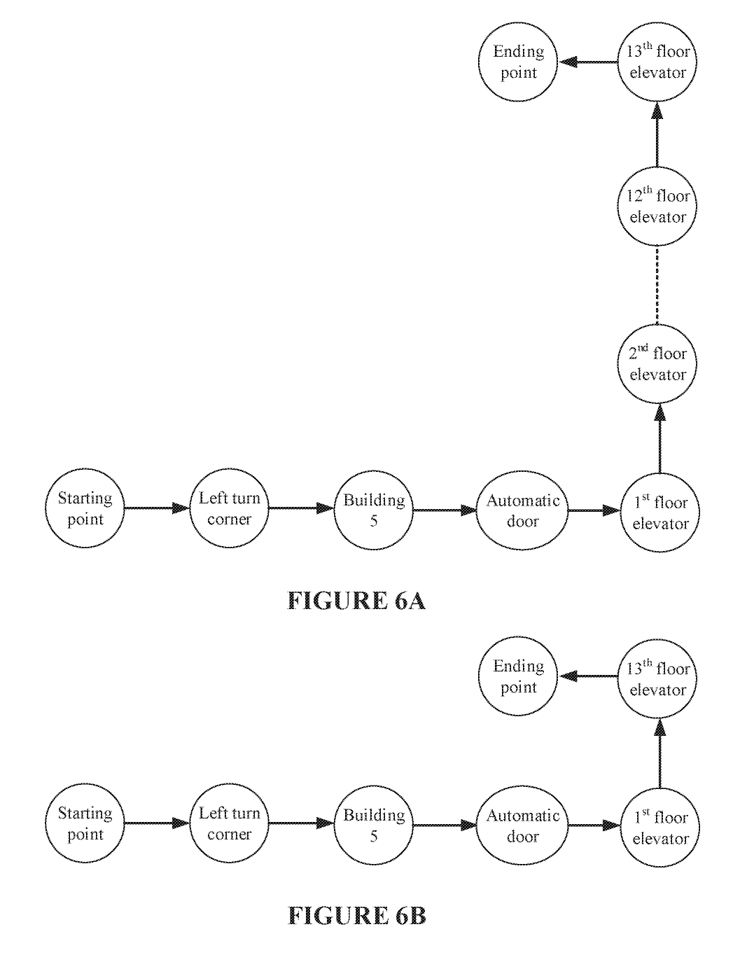

FIG. 6A and FIG. 6B illustrate an example of deleting an intermediate node. In the example, the object transport ending point is a position point on the 13^{th} floor of Building 5. In FIG. 6A, the fifth circle is the 1^{st} floor of the elevator, the 6^{th} circle, the dash line, and the 7^{th} circle indicate, the 8^{th} circle indicates the 13^{th} floor of the elevator, and the 9^{th} circle indicates the object transport ending point. In FIG. 6B, the 6^{th} circle, the dash line, and the 7^{th} circle representing the 2^{nd} to the 12^{th} floors of the elevator are deleted, leaving the 1^{st} floor and the 13^{th} floor of the elevator.

S55 includes sending the navigation route with the intermediate nodes deleted and node types of the intermediate nodes of the navigation route as navigation data to the vehicle.

In some embodiments, after the intermediate nodes are deleted in the step S54, corresponding actions need to be executed at all remaining intermediate nodes of the navigation route. Therefore, the navigation route with the intermediate nodes deleted and node types of all the intermediate nodes of the navigation route are returned to the client terminal.

With FIG. 6B as an example, the navigation route in the navigation data returned to the client terminal comprises 7 nodes, and the node types of these 7 nodes are the object transport starting point, left turn corner, Building 5, door, the 1^{st} floor of the elevator, the 13^{th} floor of the elevator, and object transport ending point, respectively.

In this example, the elevator floor is a deletable node type. In various other embodiments, the deletable node type may be another type set according to actual applications.

The above method for generating navigation data is implementable on a server. For example, a client terminal sends an object transport request to the server, and the server generates navigation data and issues the navigation data to a vehicle. Any client terminal that can connect to the server can send the object transport request to the server. When the server generates the navigation data, the server may issue the navigation data to any vehicle for it to complete the object transport task. Therefore, the disclosed object transport method is more flexible and has a broad application range.

In another example, navigation data may be directly generated on a vehicle. For example, an operator may directly input an object transport request into a vehicle, and then the vehicle generates navigation data according to the above embodiments of FIG. 3 or FIG. 5.

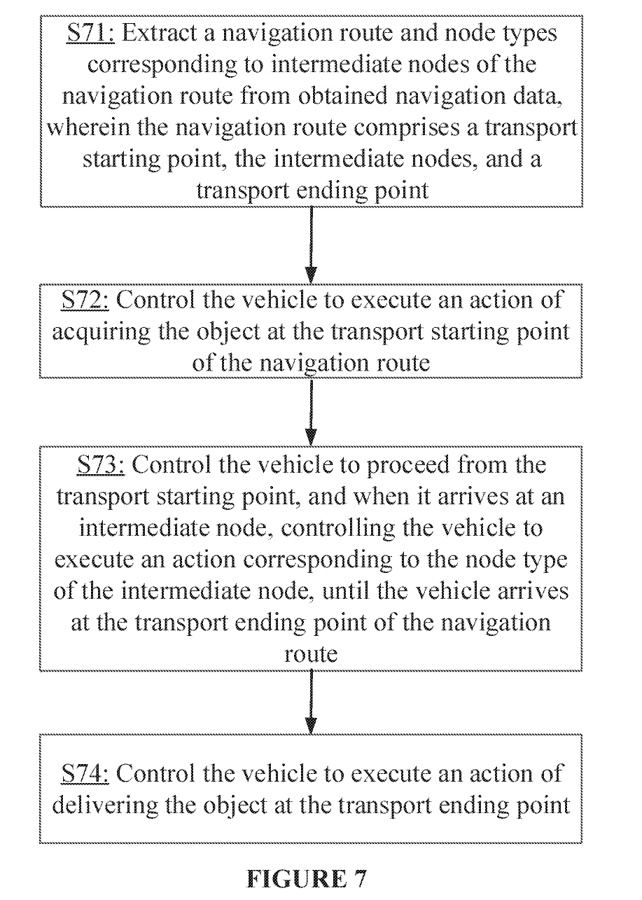

After obtaining the navigation data, the vehicle transports the object according to the navigation data. An example object transport method is shown in FIG. 7, which may comprise the steps of S71 to S74.

S71 includes extracting a navigation route and node types corresponding to intermediate nodes of the navigation route from obtained navigation data. The navigation route comprises a transport starting point, the intermediate nodes, and a transport ending point. For example, after obtaining the navigation data, a navigation route and node types corresponding to the intermediate nodes of the navigation route may be extracted from the navigation data.

In some embodiments, the navigation data comprises a navigation route. The navigation route comprises an object transport starting point, one or more intermediate nodes, and an object transport ending point. The node types of the intermediate nodes are used to instruct the vehicle to execute corresponding travel actions.

Steps S72 to S74 below may correspond to controlling the vehicle to transport an object from the transport starting point to the transport ending point, and when the vehicle arrives at the intermediate nodes, controlling the vehicle to execute actions corresponding to the node types of the intermediate nodes.

S72 includes controlling the vehicle to execute an action of acquiring the object at the transport starting point of the navigation route.

In some embodiments, the vehicle can comprise a component, e.g. a robot arm, configured to collect objects. The component may place the object in or on the vehicle at the transport starting point of the navigation route.

S73 includes controlling the vehicle to proceed from the transport starting point, and when it arrives at an intermediate node, controlling the vehicle to execute an action corresponding to the node type of the intermediate node, until the vehicle arrives at the transport ending point of the navigation route.

In some embodiments, the vehicle comprises a positioning apparatus configured to determine the real-time position of the vehicle. The apparatus that implements this method navigates the vehicle according to the navigation route and the real-time position of the vehicle determined by the positioning apparatus, such that the vehicle proceeds along the navigation route.

A corresponding relationship between node types and actions to be executed may be provided in the vehicle. For example, the action corresponding to left turn corner is to turn left, the action corresponding to Building N is to turn to the entrance to that building, the action corresponding to an automatic door is to wait for a preset time and then proceed, the action corresponding to the 1^{st} floor of the elevator is to enter the elevator, and the action corresponding to an N^{th} (N is not 1) floor of the elevator is to leave the elevator. The above description is merely exemplary. The corresponding relationship may also be other corresponding relationships between node types and actions to be executed that can be understood and expected by a person skilled in the art.

In the movement process, at each intermediate node, an action corresponding to the node type of the intermediate node can be executed. With the navigation route shown in FIG. 6B as an example, when the vehicle arrives at the 2^{nd} node (left turn corner), it may execute the left turning action; when arriving at the 3^{rd} node (Building 5), it may execute the action to turn to the entrance of the building; when arriving at the 4^{th} node (automatic door), it may execute the action to wait for the door to open and pass through the door; when arriving at the 5^{th} node (the 1^{st} floor of the elevator), it may execute the action to enter the elevator; when arriving at the 6^{th} node (the 13^{th} floor of the elevator), it may execute the action to leave the elevator; and then it arrives at the object transport ending point according to the navigation route.

The vehicle may comprise an image recognition apparatus to recognize floor numbers on the elevator. When a floor number of the elevator is recognized, a vehicle component, such as a robot arm of an intelligent robot or an alternative part, can be further controlled to execute an action of pressing a floor number button.

S74 includes controlling the vehicle to execute an action of delivering the object at the transport ending point.

In some embodiments, an object collection apparatus may be provided at the transport ending point to control a robot arm of a vehicle to deliver the object into the object collection apparatus.

In some embodiments, the action of acquiring an object in the step S72 and the action of delivering an object in the step S74 may be omitted. Alternatively, they are completed manually.

The above steps S71 to S74 may correspond a process that a vehicle is controlled to transport an object according to the navigation data and to deliver the object at a transport ending point, thereby achieving automatic delivery of objects and saving labor costs.

In some embodiments, an object transport starting point may be a fixed object management point, for example, a relay station for collecting objects. Alternatively, the object transport starting point may be any position point within a working range of a vehicle. For example, a vehicle is deployed in an office area, and any employee in the office area can use the vehicle to transport an object from his/her work station to other position points in the office area. Therefore, any position point in the office area may be used as a transport starting point for the vehicle to transport an object. The same is true with the object transport ending point, which may be a fixed object management point or any position point in the working range of the vehicle.

In some embodiments, a vehicle may use electric power to operate, and when the power is not sufficient, charging control can be performed on the vehicle.

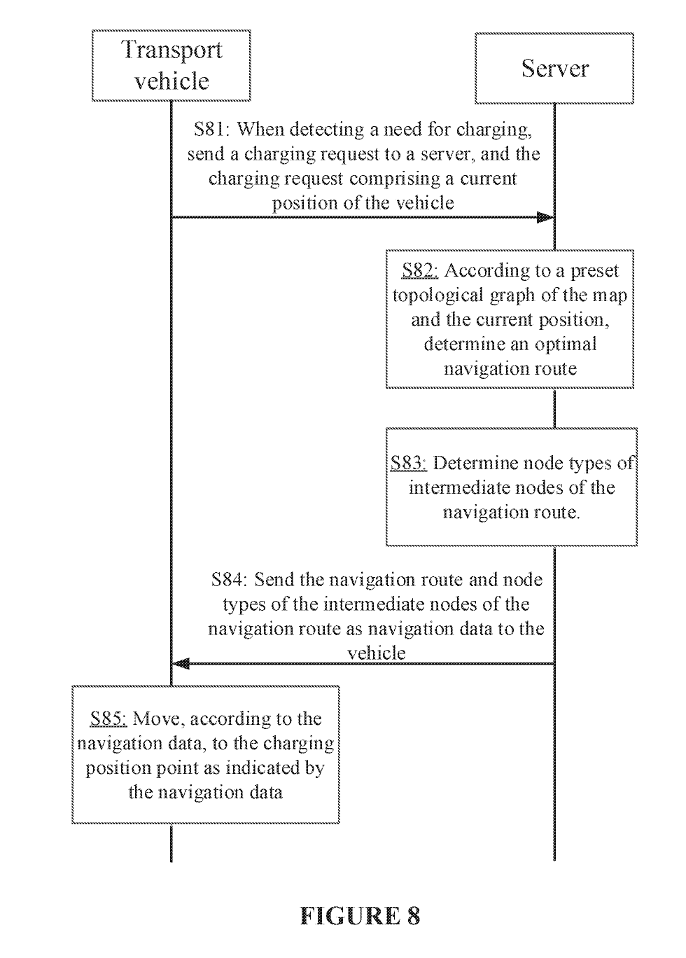

An example charging process may be as shown in FIG. 8, which comprises the following steps S81 to S85.

S81 includes, when detecting a need for charging, the vehicle sends a charging request to a server, and the charging request comprises a current position of the vehicle.

In some embodiments, the vehicle monitors the remaining power amount of its own battery, and when it determines that the remaining power is below a preset power threshold, the vehicle sends a charging request to a server. In some other embodiments, the vehicle monitors the remaining power of its own battery, and when the navigation data is acquired by executing the step S71, a power amount required from the transport starting point to the transport ending point of the navigation route in the navigation data is calculated. When the remaining power amount is lower than the required power amount, the vehicle sends a charging request to a server.

The vehicle may include the current position in the charging request sent to the server, such that the server performs route planning accordingly.

S82 includes, according to a preset topological graph of the map and the current position, the server determines an optimal navigation route.

In some embodiments, the topological graph of the map comprises nodes and lines, and a line is a route between two nodes. The topological graph of the map may record the actual length of each line. Therefore, the determined optimal navigation route may be a route with the shortest length from the current position to a charging position point. The navigation route can be used to instruct the vehicle to charge. Therefore, the navigation route may be referred to as a charging navigation route.

Furthermore, the topological graph of the map may record a time length for completing travel along each line, and then the determined optimal navigation route may be a route with the shortest time from the current position to a charging position point.

According to actual applications, the optimal navigation route may also be a route with other advantages. When calculating the optimal navigation route, the remaining power amount of the vehicle may need to be more than or equal to the power amount required by the vehicle to reach a charging position point of the navigation route.

S83 includes that the server determines node types of intermediate nodes of the navigation route.

S84 includes that the server sends the navigation route and node types of the intermediate nodes of the navigation route as navigation data to the vehicle.

In some embodiments, the navigation data may be referred to as navigation data for instructing to charge, the navigation data comprises a charging navigation route, the intermediate nodes of the charging navigation route comprise node types, and the intermediate nodes are nodes other than: a node corresponding to the current position of the vehicle and a node corresponding to the charging position.

S85 includes that the vehicle moves, according to the navigation data, to the charging position point as indicated by the navigation data.

In view of the above steps, accordingly, the vehicle may calculate or otherwise obtain a power amount required by the vehicle to transport an object from the transport starting point to the transport ending point; in response to determining a remaining power amount of the vehicle is less than the required power amount, acquire navigation data for instructing to charge, wherein the navigation data for instructing to charge comprises a charging navigation route, the charging navigation route comprises a node corresponding to a current position of the vehicle, one or more intermediate nodes of the charging navigation route, and a node corresponding to the charging position; and control the vehicle to move, according to the navigation data for instructing to charge, from the current position to the charging position.

It should be noted that the description of FIG. 3 may be referenced for a description of the above steps of S83 to S85, which will not be repeated herein.

In some embodiments, if it is the second situation of the step S81 in which the vehicle sends a charging request, i.e., the charging request is sent after executing the step S71 to acquire the navigation data, it indicates that the vehicle has received the object transport task. Therefore, when the charging is completed, the vehicle continues to execute S72 and subsequent steps to complete the object transport.

In some embodiments, the above navigation data for instructing to charge acquired by the vehicle may not be generated by the server. It can be generated by the vehicle itself. The above flow in FIG. 3 or FIG. 5 may be referenced for an example generation method, which will not be repeated herein.

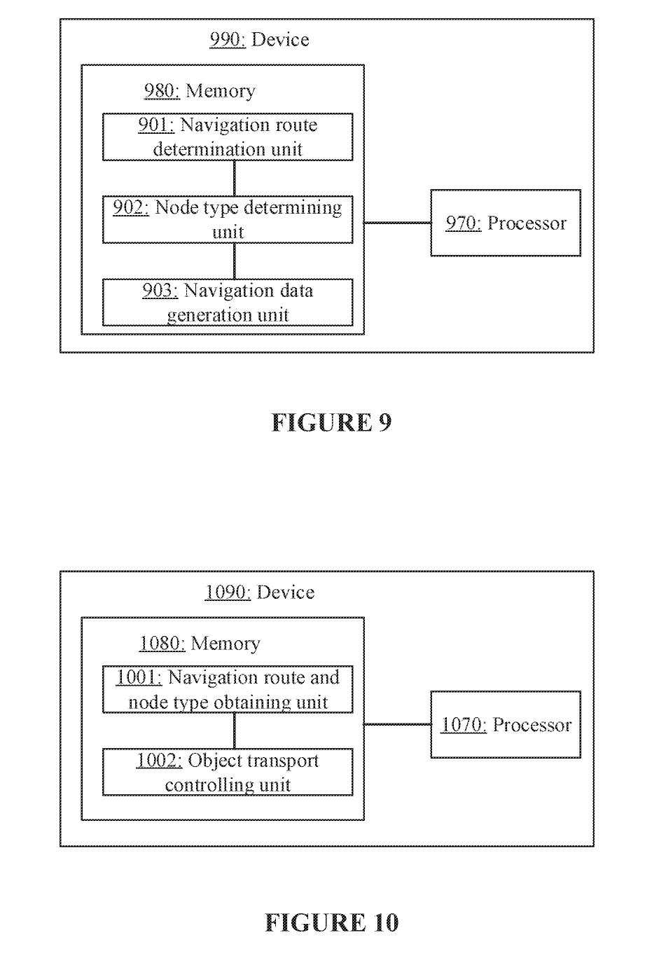

To implement the above method for generating navigation data, the disclosure further provides an example apparatus 990 for generating navigation data. As shown in FIG. 9, the apparatus 990 may comprise a non-transitory computer-readable memory 980 and a processor 970. The memory 980 may correspond to a memory 112 described below, and the processor 970 may correspond to a processor 111 described below. The memory 980 may store instructions that, when executed by the processor 111, cause the apparatus 990 to perform various steps and methods described herein. The memory 980 may comprise a navigation route determining unit 901, a node type determining unit 902, and a navigation data generating unit 903.

The navigation route determining unit 901 is configured to determine, upon receiving an object transport request, a navigation route according to the object transport request; wherein the navigation route comprises an object transport starting point, intermediate nodes, and an object transport ending point, the intermediate nodes being nodes other than the transport starting point and the transport ending point.

The node type determining unit 902 is configured to determine node types of intermediate nodes of the navigation route, the node types being used to indicate actions to be executed by a vehicle at the nodes.

The navigation data generating unit 903 is configured to use the navigation route and node types of the intermediate nodes of the navigation route to generate navigation data.

To delete repeated nodes, the above generation apparatus may further comprise a repeated node deleting unit.

The repeated node deleting unit is configured to delete, after the determining node types of intermediate nodes of the navigation route, an intermediate node of a deletable type from the intermediate nodes if the intermediate node has the same node type as that of the immediately adjacent intermediate nodes.

Correspondingly, in the aspect of the using the navigation route and node types of the intermediate nodes of the navigation route to generate navigation data, the navigation data generating unit is configured to: use the navigation route with the intermediate node deleted and node types of the intermediate nodes of the navigation route to generate navigation data.

When determining node types of intermediate nodes of the navigation route, the node type determining unit 902 is configured to: search for node types of the intermediate nodes in a pre-stored node type file. The node type file may include node types of all nodes in a topological graph of the map.

In an application example, the above apparatus is implementable on a server, and the object transport request received by the navigation route determining unit 901 is sent by a client terminal. Correspondingly, the apparatus may further comprise: a navigation data sending unit configured to send the navigation data to a vehicle.

To implement the above object transport method, the disclosure further provides an example object transport apparatus 1090. As shown in FIG. 10, the apparatus 1090 may comprise a non-transitory computer-readable memory 1080 and a processor 1070. The memory 1080 may correspond to a memory 122 described below, and the processor 1070 may correspond to a processor 121 described below. The memory 122 may store instructions that, when executed by the processor 121, cause the apparatus 1090 to perform various steps and methods described herein. The memory 122 may comprise a navigation route and node type obtaining unit 1001 and an object transport controlling unit 1002.

The navigation route and node type obtaining unit 1001 is configured to extract, after obtaining the navigation data, a navigation route and node types corresponding to the intermediate nodes of the navigation route from the navigation data. The navigation route comprises several nodes, and the intermediate nodes are nodes in the several nodes other than the transport starting point and the transport ending point.

The object transport controlling unit 1002 is configured to control the vehicle to start transporting an object from the transport starting point, and when the vehicle arrives at the intermediate nodes, control the vehicle to execute actions corresponding to the node types of the intermediate nodes, until the vehicle arrives at the transport ending point.

In some embodiments, when controlling the vehicle to execute actions corresponding to the node types of the intermediate nodes, the object transport controlling unit may execute the following steps: determining, according to a preset corresponding relationship between node types and actions to be executed, actions corresponding to the node types of the intermediate nodes; controlling the vehicle to execute the determined actions.

To achieve automatic acquisition and delivery of objects, the object transport apparatus may further comprise: an object acquisition controlling unit and an object delivery controlling unit. The object acquisition controlling unit is configured to control the vehicle to execute an action of acquiring the object at the transport starting point. The object delivery controlling unit is configured to control the vehicle to execute an action of delivering the object at the transport ending point.

To ensure that a vehicle smoothly transports an object to a designated position, the object transport apparatus may further comprise: a required power amount calculating unit, a charging navigation data acquiring unit, and a charging movement controlling unit.

The required power amount calculating unit is configured to calculate, before the controlling the vehicle to start transporting an object from the transport starting point, a power amount required by the vehicle to transport an object from the transport starting point to the transport ending point.

The charging navigation data acquiring unit is configured to acquire, if the remaining power amount of the vehicle is less than the required power amount, navigation data for instructing to charge. The navigation data for instructing to charge comprises a charging navigation route, intermediate nodes of the charging navigation route comprise node types, and the intermediate nodes are nodes other than: a node corresponding to the current position of the vehicle and a node corresponding to the charging position.

The charging movement controlling unit is configured to control the vehicle to move, according to the navigation data for instructing to charge, from the current position to the charging position.

FIG. 11 is a schematic diagram of an architecture of an example server, comprising: a controller/processor 111, a memory 112, a communication port 113, an input device 114, and an output device 115 coupled to a bus. The processor 111, the memory 112, the communication port 113, the input device 114, and the output device 115 are mutually connected via the bus, wherein the bus may comprise a channel for transmitting information among parts of a computer system.

The controller/processor 111 may be a general-purpose processor, such as CPU, Network Processor (NP), microprocessor, etc., or may be an application-specific integrated circuit (ASIC), or one or more integrated circuits to control execution of programs according to the solutions of the present disclosure. Furthermore, it may be a digital signal processor (DSP), an application-specific integrated circuit (ASIC), a field-programmable gate array (FPGA), other programmable logic devices, discrete gate or transistor logic devices, discrete hardware assemblies, etc. The controller/processor 111 may also be a combination to achieve computing functions, for example, a combination comprising one or more microprocessors, a combination of DSP and microprocessors, etc.

The controller/processor 111 may be used to execute steps, for example, S82 and S83, in FIG. 3, FIG. 5, and FIG. 8 and/or other processes of the technologies set forth in the disclosure.

The memory 112 stores a program for executing the technical solution of the disclosure, and may further store an operating system and other applications. The program may comprise program codes, and the program codes comprise computer instructions. For example, the memory 112 may comprise read-only memory (ROM), other types of static storage devices capable of storing static information and instructions, random access memory (RAM), other types of dynamic storage devices capable of storing information and instructions, magnetic disk memory, etc. In some embodiments, the memory may be non-transitory and computer-readable and may store instructions that, when executed by the processor, cause the processor to perform various methods and steps described herein.

The communication port 113 may comprise any transceiver-like apparatuses for communications with other devices or communication networks, such as ethernet, Radio Access Network (RAN), and wireless local area network (WLAN).

The input device 114 may comprise an apparatus to receive data and information input by a user, such as keyboard, mouse, camera, scanner, optical pen, voice input apparatus, touchscreen, etc.

The output device 115 may comprise an apparatus that enables information output to a user, such as monitor, printer, speaker, etc.

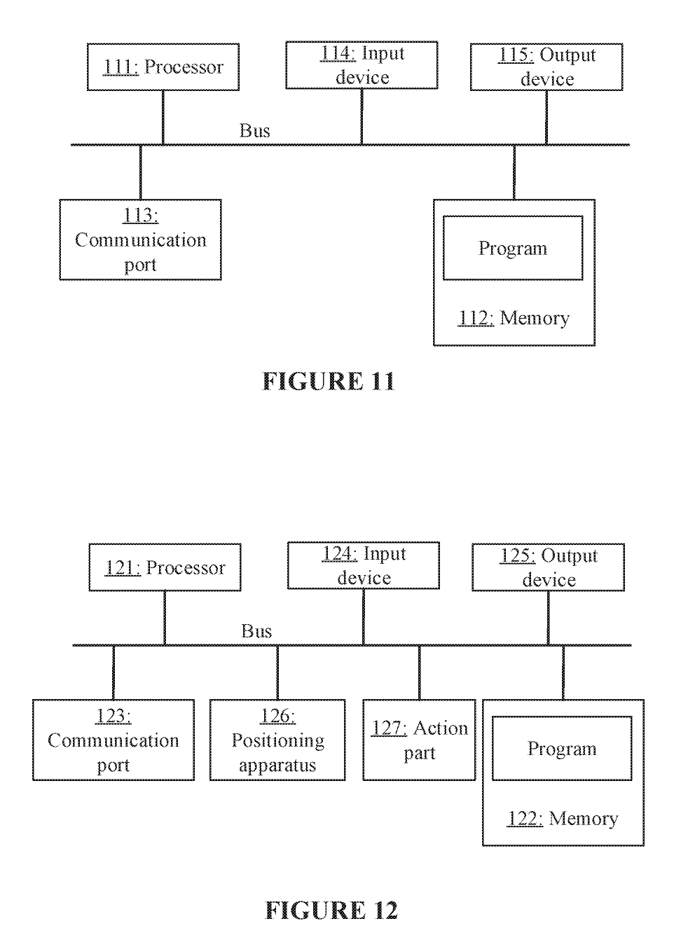

FIG. 12 is a schematic diagram of a potential architecture of a vehicle. The vehicle may comprise a controller/processor 121, a memory 122, a communication port 123, an input device 124, and an output device 125 coupled to a bus, similar to the controller/processor 111, the memory 112, the communication port 113, the input device 114, and the output device 115 described above. The vehicle may further comprise: a positioning apparatus 126 and an action part 127.

Any existing positioning system may be used as the positioning apparatus 126, such as the Global Positioning System (GPS), the BeiDou Navigation Satellite System (BDS), etc. The positioning apparatus 126 is configured to determine, in real time, the position of the vehicle.

The controller/processor 121 of the vehicle may be configured to extract, after obtaining the navigation data, a navigation route and node types corresponding to the intermediate nodes of the navigation route from the navigation data, send a moving instruction, according to the position determined by the positioning apparatus and the navigation route, to the action part, and send an action instruction, according to the node type, to the action part.

The controller/processor 121 of the vehicle may be used to execute steps, for example, S81, S84, and S85, in FIG. 7 and FIG. 8 and/or other processes of the technologies set forth in the disclosure.

The action part 127 may comprise a moving part, such as wheels of a self-balancing scooter, and an action part, such as a robot arm. Here, the action part 127 may be used to start transporting an object from the transport starting point according to the moving instruction, and when the vehicle arrives at the intermediate nodes, execute an action corresponding to the action instruction, until the vehicle arrives at the transport ending point.

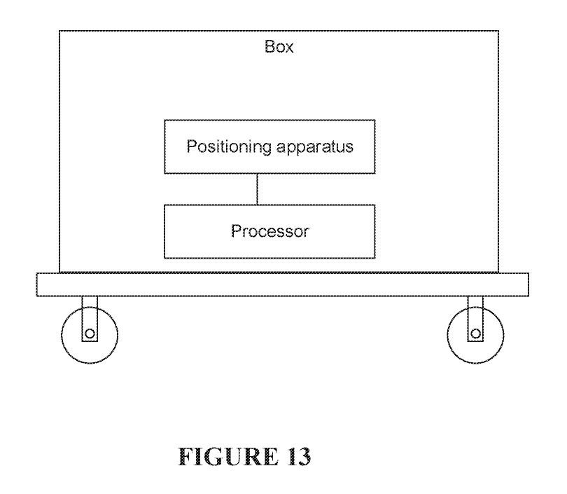

FIG. 13 illustrates an example vehicle according to the disclosure, comprising a processor, a positioning apparatus, and an action part. The positioning apparatus is configured to determine the position of the vehicle in real time.

The processor is configured to determine, upon receiving an object transport request, a navigation route according to the object transport request, and determine node types of intermediate nodes of the navigation route. The navigation route comprises an object transport starting point, intermediate nodes, and an object transport ending point. The intermediate nodes are nodes other than the transport starting point and the transport ending point, and the node types are used to indicate actions to be executed by the vehicle at the nodes. The processor may be further configured to send a moving instruction, according to the position determined by the positioning apparatus and the navigation route, to the action part, and to send an action instruction, according to the node type, to the action part.

The action part is configured to start transporting an object from the transport starting point according to the moving instruction, and when the vehicle arrives at the intermediate nodes, execute an action corresponding to the action instruction, until the vehicle arrives at the transport ending point.

As shown in FIG. 13, a box may be provided on the vehicle for holding an object, and the action part on the vehicle may be wheels or belts. The vehicle may generate a navigation route on its own. For example, an operator inputs an object transport request that comprises a transport starting point and a transport ending point into the vehicle via an operating interface, a topological graph of the map of the working environment is pre-stored on the vehicle, which then uses the topological graph of the map to generate a navigation route, and controls movements of its own action parts according to the navigation route.

The embodiments in this description are described in a progressive manner with each embodiment focused on differences from other embodiments, and the embodiments may be mutually referenced for identical or similar parts thereof.

Relational terms, such as first and second, in this description are only used to differentiate one entity or operation from another entity or operation, while not necessarily requiring or implying the existence of any of such an actual relation or sequence among these entities or operations. Moreover, the terms of “including”, “comprising” or any other variants thereof intend to encompass a non-exclusive inclusion, such that a process, method, object or device comprising a series of elements not only comprises these elements, but also comprises other elements that are not specifically listed, or further comprises elements that are inherent to the process, method, object or device. When there is no further restriction, elements defined by the statement “comprising one . . . ” does not exclude that a process, method, object or device comprising the above elements further comprises other identical elements.

The above description of the disclosed embodiments enables a person skilled in the art to implement or use the disclosure. A variety of modifications to these embodiments would be obvious to a person skilled in the art, and the general principle defined herein may be implemented in other embodiments without departing from the spirit or scope of the disclosure. Therefore, the disclosure will not be limited to these embodiments herein, but will comply with the broadest scope that is consistent with the principle and novel features disclosed herein.

1. A method for generating navigation data, comprising:
determining a navigation route according to a received object transport request, wherein the navigation route comprises an object transport starting point, one or more intermediate nodes, and an object transport ending point;
determining node types of the intermediate nodes, the node types indicating actions to be executed by a vehicle at the corresponding nodes; and
obtaining navigation data based at least on the navigation route and the node types of the intermediate nodes.

2. The method for generating navigation data according to claim 1, wherein,
after determining node types of the intermediate nodes, the method further comprises:
removing an intermediate node of a deletable type from the intermediate nodes in response to determining that the deletable intermediate node and one or more immediately adjacent intermediate nodes have a same node type; and
obtaining the navigation data based at least on the navigation route and the node types of the intermediate nodes comprises: obtaining navigation data based at least on the navigation route with the deletable intermediate node removed and the node types of the intermediate nodes.

3. The method for generating navigation data according to claim 1, wherein determining the node types of the intermediate nodes comprises:
searching for the node types of the intermediate nodes in a node type file, wherein the node type file comprises node types of the nodes in a topological map.

4. The method for generating navigation data according to claim 1, implementable on a server, wherein:
the object transport request is received from a client terminal;
the method further comprises sending the navigation data to a vehicle.

5. The method for generating navigation data according to claim 1, wherein the method is implementable on a vehicle.

6. An object transport method, implementable on a vehicle, the method comprising:
extracting a navigation route and node types corresponding to intermediate nodes of the navigation route from obtained navigation data, wherein the navigation route comprises a transport starting point, the intermediate nodes, and a transport ending point; and
controlling the vehicle to transport an object from the transport starting point to the transport ending point, and when the vehicle arrives at the intermediate nodes, controlling the vehicle to execute actions corresponding to the node types of the intermediate nodes.

7. The object transport method according to claim 6, wherein controlling the vehicle to execute the actions corresponding to the node types of the intermediate nodes comprises:
determining, according to a preset corresponding relationship between node types and actions to be executed, the actions corresponding to the node types of the intermediate nodes; and
controlling the vehicle to execute the determined actions.

8. The object transport method according to claim 6, further comprising:
controlling the vehicle to execute an action of acquiring the object at the transport starting point; and
controlling the vehicle to execute an action of delivering the object at the transport ending point.

9. The object transport method according to claim 6, wherein, before controlling the vehicle to transport the object from the transport starting point to the transport ending point, the method further comprises:
obtaining a power amount required by the vehicle to transport an object from the transport starting point to the transport ending point;
in response to determining a remaining power amount of the vehicle is less than the required power amount, acquiring navigation data for instructing to charge, wherein the navigation data for instructing to charge comprises a charging navigation route, the charging navigation route comprises a node corresponding to a current position of the vehicle, one or more intermediate nodes of the charging navigation route, and a node corresponding to the charging position; and
controlling the vehicle to move, according to the navigation data for instructing to charge, from the current position to the charging position.

10. An apparatus for generating navigation data, comprising a processor and a non-transitory computer-readable storage medium storing instructions that, when executed by the processor, cause the apparatus to perform a method, the method comprising:
determining a navigation route according to a received object transport request, wherein the navigation route comprises an object transport starting point, one or more intermediate nodes, and an object transport ending point;
determining node types of the intermediate nodes, the node types indicating actions to be executed by a vehicle at the corresponding nodes; and
obtaining navigation data based at least on the navigation route and the node types of the intermediate nodes.

11. The apparatus for generating navigation data according to claim 10, wherein:
after determining node types of the intermediate nodes, the method further comprises:
removing an intermediate node of a deletable type from the intermediate nodes in response to determining that the deletable intermediate node and one or more immediately adjacent intermediate nodes have a same node type; and
obtaining the navigation data based at least on the navigation route and the node types of the intermediate nodes comprises: obtaining navigation data based at least on the navigation route with the deletable intermediate node removed and the node types of the intermediate nodes.

12. The apparatus for generating navigation data according to claim 10, wherein, determining the node types of the intermediate nodes comprises:
searching for the node types of the intermediate nodes in a node type file, wherein the node type file comprises node types of the nodes in a topological map.

13. The apparatus for generating navigation data according to claim 10, implementable on a server, wherein:
the object transport request is received from a client terminal; and
the method further comprises: sending the navigation data to a vehicle.

14. An object transport apparatus, implementable on a vehicle, the apparatus comprising a processor and a non-transitory computer-readable storage medium storing instructions that, when executed by the processor, cause the apparatus to perform a method, the method comprising:
extracting a navigation route and node types corresponding to intermediate nodes of the navigation route from obtained navigation data, wherein the navigation route comprises a transport starting point, the intermediate nodes, and a transport ending point; and
controlling the vehicle to transport an object from the transport starting point to the transport ending point, and when the vehicle arrives at the intermediate nodes, controlling the vehicle to execute actions corresponding to the node types of the intermediate nodes.

15. The object transport apparatus according to claim 14, wherein, controlling the vehicle to execute the actions corresponding to the node types of the intermediate nodes comprises:
determining, according to a preset corresponding relationship between node types and actions to be executed, the actions corresponding to the node types of the intermediate nodes; and
controlling the vehicle to execute the determined actions.

16. The object transport apparatus according to claim 14, wherein the method further comprises:
controlling the vehicle to execute an action of acquiring the object at the transport starting point;
controlling the vehicle to execute an action of delivering the object at the transport ending point.

17. The object transport apparatus according to claim 14, wherein, before controlling the vehicle to transport the object from the transport starting point to the transport ending point, the method further comprises:
obtaining a power amount required by the vehicle to transport an object from the transport starting point to the transport ending point;
in response to determining a remaining power amount of the vehicle is less than the required power amount, acquiring navigation data for instructing to charge, wherein the navigation data for instructing to charge comprises a charging navigation route, the charging navigation route comprises a node corresponding to a current position of the vehicle, one or more intermediate nodes of the charging navigation route, and a node corresponding to the charging position; and
controlling the vehicle to move, according to the navigation data for instructing to charge, from the current position to the charging position.

18. A server, comprising:
a processor configured to:
determine a navigation route according to a received object transport request, wherein the navigation route comprises an object transport starting point, one or more intermediate nodes, and an object transport ending point;
determine node types of the intermediate nodes, the node types indicating actions to be executed by a vehicle at the corresponding nodes; and
obtain navigation data based at least on the navigation route and the node types of the intermediate nodes; and
a communication port configured to transmit the navigation data.

19. A vehicle, comprising:
a communication port configured to receive navigation data comprising one or more intermediate nodes;
a positioning apparatus configured to determine a position of the vehicle in real time;
a processor configured to:
extract a navigation route in the navigation data and node types corresponding to the intermediate nodes, wherein the navigation route comprises a transport starting point, the intermediate nodes, and a transport ending point; and
send a moving instruction, according to the determined position and the navigation route, to the action part; and send an action instruction, according to the node type, to an action part; and
the action part configured to transport an object from the transport starting point to the transport ending point according to the moving instruction, and when the vehicle arrives at each of the intermediate nodes, execute an action corresponding to the action instruction.

20. A vehicle, comprising:
a positioning apparatus configured to determine a position of the vehicle in real time;
a processor configured to:
determine a navigation route according to a received object transport request and determine node types of one or more intermediate nodes, wherein the navigation route comprises an object transport starting point, the intermediate nodes, and an object transport ending point, and the node types indicate actions to be executed at the nodes; and
send a moving instruction, according to the determined position and the navigation route, to the action part; and send an action instruction, according to the node type, to an action part; and
the action part configured to start transport an object from the transport starting point to the transport ending point according to the moving instruction, and when the vehicle arrives at each of the intermediate nodes, execute an action corresponding to the action instruction.
